(19) United States
(12) Patent Application Publication
(10) Pub. No.: US 2025/0343258 A1
(43) Pub. Date: Nov. 6, 2025

(54) TOOL ASSEMBLY AND METHOD FOR FILLING A BATTERY PACK WITH A POTTING MATERIAL

(71) Applicant: GM Global Technology Operations LLC, Detroit, MI (US)

(72) Inventors: Anthony Michael Coppola, Rochester Hills, MI (US); Steven Cipriano, Chesterfield Township, MI (US); Tyler Talaski, Clarkston, MI (US); Anna Bouma, Grosse Pointe Park, MI (US); Abrielle R. Sommers, Swartz Creek, MI (US); Mohammad Hamza Kirmani, Troy, MI (US)

(21) Appl. No.: 18/653,415

(22) Filed: May 2, 2024

(51) Int. Cl. H01M 10/04; H01M 10/615; H01M 10/653; H01M 10/66; H01M 50/238; H01M 50/293

(52) U.S. Cl. CPC H01M 10/0481; H01M 10/615; H01M 10/653; H01M 10/66; H01M 50/238; H01M 50/293

(57) ABSTRACT

A method for manufacturing a battery includes filling a battery pack with a potting material and clamping the battery pack with a clamp to apply a clamping force on the battery back while the potting material is inside the battery pack. The clamp includes a clamping arm and a rigid base plate. The method further includes maintaining the clamping force on the battery pack while the potting material foams to minimize deformation of the battery pack while the potting material expands during curing. Further, the method further includes unclamping the battery pack.

### INTRODUCTION

The present disclosure relates to a tool assembly and method for filing a battery pack with potting material.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Batteries packs are filled with potting foam to encapsulate internal components inside the battery packs. The pressure exerted on the battery pack by the foam expansion would cause the pack to bulge and possibly fail to comply with the dimensional tolerances. It is therefore desirable to develop a tool assembly and method for minimizing the expansion of the battery pack during the foam expansion.

### SUMMARY

The present disclosure describes a battery manufacturing method. The method includes filling a battery pack with a potting material and clamping the battery pack with a clamp to apply a clamping force on the battery back while the potting material is inside the battery pack. The clamp includes a clamping arm and a rigid base plate. The clamping arm is movable relative to the rigid base plate. The method may further includes maintaining the clamping force on the battery pack while the potting material cures to minimize deformation of the battery pack while the potting material expands during curing and then unclamping the battery pack after the potting material is cured.

The clamp is part of a tool assembly, and the tool assembly includes a spring coupled to the clamping arm. The battery pack includes a first shear plate, a second shear plate, and a plurality of battery cells between the first shear plate and the second shear plate. The clamping arm includes an edge clamping portion, and the edge clamping portion is in direct contact with the first shear plate. The clamping arm includes a central clamping portion, and the spring is directly coupled to the central clamping portion. The clamp further includes a press plate. The spring is directly coupled to the press plate. The press plate is configured to be placed in direct contact with the first shear plate. The rigid base plate is in direct contact with the second shear plate. The tool assembly includes a heater exchanger in thermal communication with the central clamping portion. The method may include heating the central clamping portion of the clamp.

The present disclosure also describes a tool assembly. The tool assembly also includes a clamp including a clamping arm and a rigid base plate. The clamp is configured to clamp a battery pack. The tool assembly further includes a nozzle in fluid communication with the battery pack. The nozzle is configured to deliver a potting material while the clamp applies a clamping force on the battery pack.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic diagram of a tool assembly for filling a battery pack with a potting material.

FIG. 2 is a method for filling a battery pack with a potting material with the tool assembly of FIG. 1.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps.

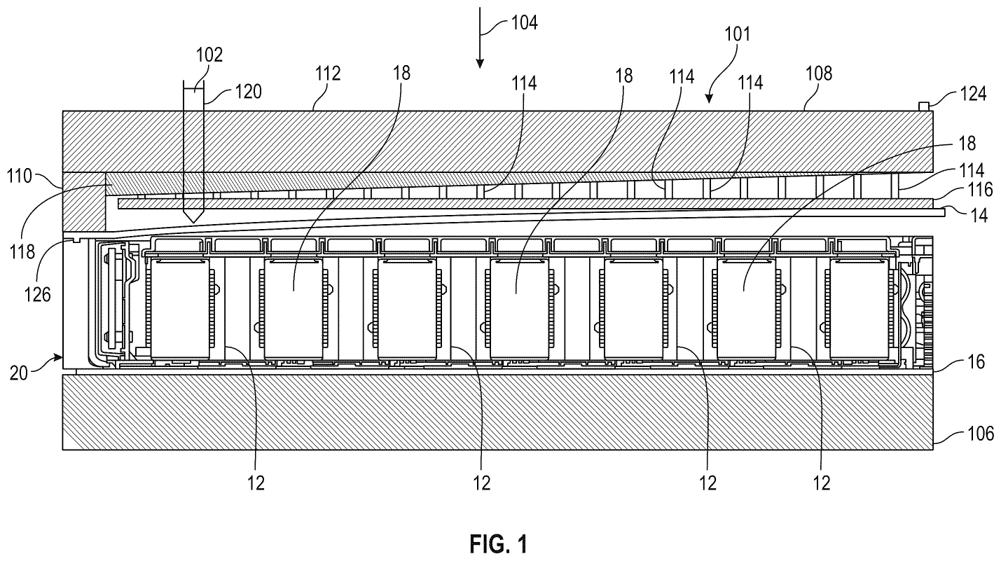

With reference to FIG. 1, a tool assembly 100 is designed to minimize deformation of a battery pack 10 when filling the battery pack 10 with a potting material 102. In the present disclosure, the term “potting material” means a polymeric material that can be applied in bulk fluid form (e.g., liquid state) and subsequently foams and becomes relatively rigid (e.g., solid state). The potting material 102 is a thermoset that, when cured, forms a chemically blown foam. As non-limiting examples, the potting material 102 may be a resin based on polyurethane, epoxy, and/or silicone. During curing, the potting material 102 foams and therefore expands. This foam expansion by the potting material exerts pressure on the battery pack 10. As a consequence, the battery pack 10 may bulge and cause the dimensions of the battery pack 10 to be outside the predetermined dimensional tolerances. The tool assembly 100 applies a clamping force on the battery pack 10 to control the foam expansion of the potting material 102 while allowing certain degree of expansion of the battery pack 10 while the potting material 102 cures. The tool assembly 100 includes one or more nozzles 120 in fluid communication with the battery pack 10 to allow the potting material 102 to be delivered inside the battery pack 10. While one nozzle 120 is shown, it is contemplated that the tool assembly 100 may include some nozzles 120 at the edge of the tool assembly 100 and other nozzles at the center of the tool assembly 100. The tool assembly 100 minimizes minimize the cycle time to produce each battery pack 10 and improves quality by meeting the dimensional tolerances of the battery pack 10. The tool assembly 100 does not necessarily include a nozzle 120. In such a case, the potting material 102 is poured into the battery pack 10 without the cover (i.e., the lower shear plate installed). Then, the tool assembly 100 is clamped in place, squeezing the excess potting material 102 out of the gap between the lower shear plate and the TRP tray. Then, as the foam expands, it presses against the controlled displacement stage, minimizing its thickness and limiting its total thickness.

The battery pack 10 includes a first shear plate 14, a second shear plate 16, and a plurality of battery cells 12 entirely disposed between the first shear plate 14 and the second shear plate 16. The battery pack 10 defines a plurality of voids 18 that are filled with potable material to maintain the structural integrity of the battery pack 10 during use. The voids 18 are entirely disposed between the first shear plate 14 and the second shear plate 16.

The tool assembly 100 includes a clamp 101 for applying a clamping force on the battery pack 10 to minimize deformation of the battery pack 10 while the potting material cures and foams while curing. To do so, the tool assembly 100 includes a rigid base plate 106 and a clamping arm 108 movable relative to the rigid base plate 106. The clamping arm 108 includes an edge clamping portion 110 and a central clamping portion 112. The edge clamping portion 110 is configured to be placed in direct contact with the first shear plate 14, thereby providing a stiff load path from the clamping arm 108 to the first shear plate 14 of the battery pack 10. As a result, no deformation occurs at the perimeter of the first shear plate 14 when the clamping arm 108 applies the clamping force 104 on the battery pack 10. The edge clamping portion 110 of the clamping arm 108 applies sufficient force and has sufficient stiffness to ensure that the first shear plate 14 seals against an enclosure 20 of the battery pack 10 while allowing the central plate portion 122 of the first shear plate 14 to deform and not be flat by as much as ten millimeters.

The clamp 101 further includes one or more springs 114 (e.g., coil springs, wave springs, rubber, foam, hydraulic or pneumatic pistons, air bladder, flexible metal plate, etc.) coupled to the clamping arm 108. The springs 114 could be just located at the edges of the clamping arm 108 or may be positioned continuously along the length of the clamping arm 108. The springs 114 may touch the battery pack 10 first and may be pre-loaded. Moreover, the clamp 101 further includes a press plate 116 directly coupled to the springs 114. Thus, the springs 114 may be directly coupled to the press plate 116. The press plate 116 is configured to be placed in direct contact with the first shear plate 14. Because the press plate 116 is connected to the clamping arm 108 through the springs 114, the press plate 116 is movable relative to the clamping arm 108, and the springs 114 bias the press plate 116 away from the clamping arm 108. Due to the spring connection between the press plate 116 and the clamping arm 108, some deformation may occur at the central plate portion 122 of the first shear plate 14 (as shown in FIG. 1) when the potting material 102 foams and the clamping arm 108 applies the clamping force 104 to the battery pack 10.

Optionally, the clamp 101 includes a mechanical stop 118 to limit the deformation of the first shear plate 14 when the potting material 102 foams and the clamping arm 108 applies the clamping force 104 to the battery pack 10. The mechanical stop 118 is disposed between the clamping arm 108 and the springs 114. It is contemplated that the mechanical stop 118 may have a profiled shaped (e.g., wedge-shaped) to allow a gradual deformation of the first shear plate 14 and tailored foam expansion.

The central clamping portion 112 of the clamping arm 108 allows a controlled amount of deflection in the first shear plate 14 up to an upper limit provided by the mechanical stop 118. The controlled deflection of the first shear plate 14 is achieved using the springs 114. The springs 114 apply a spring force to bias the press plate 116 away from the clamping arm 108. This spring force may be applied by a fluid, such as a bladder filled with air or a mechanical device like a pneumatic or hydraulic cylinder.

The tool assembly 100 may further include a heat exchanger 124 (e.g., an electric heater, circulation of fluid in the tool assembly 100, and/or circulation of fluid within the spring stage) in thermal communication with the clamping arm 108. The heater exchanger 124 may be activated to transfer heat from the clamping arm 108 to the potting material 102 inside the battery pack 10. As a consequence, the potting material 102 may be locally cured and the clamping time is reduced. The heater exchanger 124 may be an independent from the tool assembly 100 and can heat the tool assembly 100 between uses. The heater exchanger 124 may be removed before the clamp 101 is moved into position, allowing the energy stored as heat in the tool assembly 100 to be transferred into the first shear plate 14 to accelerate curing of the potting material 102. During use, the clamping arm 108 is held in place for a sufficient period of time to cure the potting material 102 to a state (e.g., a solid state) where the potting material 102 is self-supporting and will not significantly bulge the battery pack 10 any further.

The tool assembly 100 may further include one or more alignment features (e.g., locating pin, boss, and/or protrusion) coupled to the clamping arm 108. The alignment features 126 are configured to mate with other alignment features (e.g., locating holes) in the first shear plate 14 of the battery pack 10 to align the clamping arm 108 with the first shear plate 14. The alignment features 126 also act to keep the potting material 102 or other adhesives from blocking the clearance holes for fasteners or electrical headers.

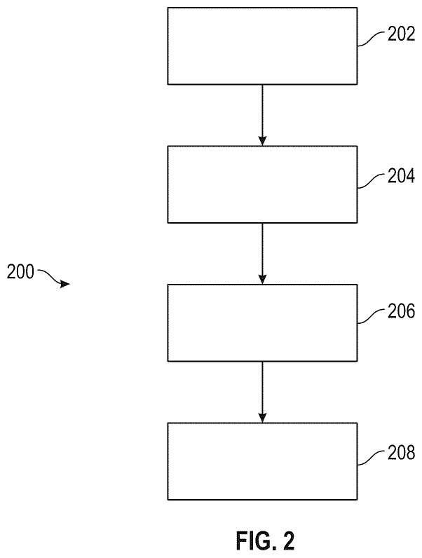

FIG. 2 is a flowchart of a battery manufacturing method 200. The method 200 begins at block 202. Block 202 entails filling the battery pack 10 with potting material 102 using the nozzle 120. At this point, the first shear plate 14 is not covering the enclosure 20 of the battery pack 10, and the potting material 102 is in liquid state. Therefore, the potting material 102 may be introduced into the enclosure 20 of the battery pack 10. Then, the method 200 continues to block 204.

At block 204, the first shear plate 14 is placed over (and coupled to) the enclosure 20 of the battery pack 10. Then, the battery pack 10 is clamped with the clamp 101 to apply a clamping force 104 on the battery pack 10 while the potting material 102 is inside the battery pack 10. The clamping force 104 is applied to the battery pack 10 through the clamping arm 108. Specifically, the clamping force 104 causes the clamping arm 108 to move toward the rigid base plate 106 while the battery pack 10 is positioned between the clamping arm 108 and the rigid base plate 106. The movement of the central clamping portion 112 toward the rigid base plate 106 causes the excess potting material 102 to be squeezed out through a gap between a battery module and the enclosure 20, allowing the potting material 102 to expand with a known force profile. As discussed above, the mechanical stop 118 serves as a constraint to the allowable displacement of the potting material 102. Then, the method 200 continues to block 206.

At block 206, the potting material 102 inside the battery pack 10 is cured by, for example, heating the potting material 102 using the heater exchanger 124. The potting material 102 disposed at the center of the battery pack and the potting material 102 disposed at the edge of the battery pack 10 may have different cure rates. For example, the cure rate of the potting material 102 disposed at the center of the battery pack 10 may be greater than the cure rate of the potting material 102 disposed at the edges of the battery pack 10. The second shear plate 16 may be pre-heated to aid in curing the potting material 102. The first shear plate 14 may be fastened to the enclosure 20 while the tool assembly 100 clamps the battery pack 10, holding the first shear plate 14 in place and providing additional structural performance to the final part. Then, the method 200 continues to block 208.

At block 208, the battery pack 10 is unclamped to withdraw the tool assembly 100 from the battery pack 10. The battery pack 10 may be unclamped after the potting material 102 is fully or partially cured. To unclamped the battery pack 10, the clamping arm 108 is moved away from the rigid base plate 106.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the presently disclosed system and method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Embodiments of the present disclosure are described herein. It is to be understood, however, that the disclosed embodiments are merely examples and other embodiments can take various and alternative forms. The figures are not necessarily to scale; some features could be exaggerated or minimized to display details of particular components. Therefore, specific structural and functional details disclosed herein are not to be interpreted as limiting, but merely as a representative basis for teaching one skilled in the art to variously employ the presently disclosed system and method. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A battery manufacturing method, comprising:
filling a battery pack with a potting material;
clamping the battery pack with a clamp to apply a clamping force on the battery pack while the potting material is inside the battery pack, wherein the clamp includes a clamping arm and a rigid base plate, and the clamping arm is movable relative to the rigid base plate;
maintaining the clamping force on the battery pack while the potting material cures to minimize deformation of the battery pack while the potting material expands during curing; and
unclamping the battery pack after the potting material is cured.

2. The method of claim 1, wherein the clamp is part of a tool assembly, and the tool assembly includes a spring coupled to the clamping arm.

3. The method of claim 2, wherein the battery pack includes a first shear plate, a second shear plate, and a plurality of battery cells between the first shear plate and the second shear plate, the clamping arm includes an edge clamping portion, and the edge clamping portion is in direct contact with the first shear plate.

4. The method of claim 3, wherein the clamping arm includes a central clamping portion, and the spring is directly coupled to the central clamping portion.

5. The method of claim 4, wherein the clamp further includes a press plate, the spring is directly coupled to the press plate, and the press plate is configured to be placed in direct contact with the first shear plate.

6. The method of claim 5, wherein the rigid base plate is in direct contact with the second shear plate.

7. The method of claim 6, wherein the tool assembly includes a heater in thermal communication with the central clamping portion, and the method further comprises heating the central clamping portion of the clamp.

8. A tool assembly, comprising;
a clamp including a clamping arm and a rigid base plate, wherein the clamp is configured to clamp a battery pack; and
a nozzle in fluid communication with the battery pack, wherein the nozzle is configured to deliver a potting material while the clamp applies a clamping force on the battery pack.

9. The tool assembly of claim 8, wherein the tool assembly includes a spring coupled to the clamping arm.

10. The tool assembly of claim 9, wherein the battery pack includes a first shear plate, a second shear plate, and a plurality of battery cells between the first shear plate and the second shear plate, the clamp includes an edge clamping portion, the edge clamping portion is in direct contact with the first shear plate.

11. The tool assembly of claim 10, wherein the clamp includes a central clamping portion, and the spring is directly coupled to the central clamping portion.

12. The tool assembly of claim 11, wherein the clamp further includes a press plate, the spring is directly coupled to the press plate, and the press plate is configured to be placed in direct contact with the first shear plate.

13. The tool assembly of claim 12, wherein the clamp includes a central clamping portion, and the spring is directly coupled to the central clamping portion.

14. The tool assembly of claim 13, wherein the clamp further includes a press plate, the spring is directly coupled to the press plate, and the press plate is directly coupled to the first shear plate.

15. The tool assembly of claim 14, wherein the rigid base plate is in direct contact with the second shear plate.

16. The tool assembly of claim 15, wherein the tool assembly includes a heater in thermal communication with the central clamping portion.

17. A tool assembly, comprising;
a clamp including a clamping arm and a rigid base plate, wherein the clamp is configured to clamp a battery pack, wherein the clamping arm includes a central clamping portion;
a heater exchanger in thermal communication with the central clamping portion.

18. The tool assembly of claim 17, further comprising a spring coupled to the clamping arm.

19. The tool assembly of claim 18, wherein the battery pack includes a first shear plate, a second shear plate, and a plurality of battery cells between the first shear plate and the second shear plate, the clamp includes an edge clamping portion, the edge clamping portion is in direct contact with the first shear plate.

20. The tool assembly of claim 19, wherein the spring is directly coupled to the central clamping portion.
